(19) United States
(12) Patent Application Publication
(10) Pub. No.: US 2002/0153466 A1
(43) Pub. Date: Oct. 24, 2002

(54) T-post support

(76) Inventor: George William Wadsworth, Louisville, TN (US)

Correspondence Address: Katerine P. Lovingood, 3203 Miser Station Road, Louisville, TN, 37777, US

(21) Appl. No.: 09/839,758

(22) Filed: Apr. 23, 2001

(51) Int. Cl. F16M 13/00

(52) U.S. Cl. 248/514; 248/530; 248/521

(57) ABSTRACT

An apparatus for supporting a metal post while it is being driven into the ground. This apparatus allows a single worker to both hold the post steady as well as pound it at the same time.

### BACKGROUND OF THE INVENTION

This invention relates to an apparatus for supporting a t-post, particularly while it is being pounded into the ground.

### DESCRIPTION OF THE INVENTION

### Background of the Invention

T-posts are metal posts that have the cross-section shape of a “T” or a similar shape to facilitate the mounting of wire supports, metal signs or other articles that need to be placed on post supports. A common use of t-posts is to build a farm fence. Metal t-posts are pounded into the ground and brackets that support wire are attached. Generally t-posts are pounded vertical to the ground, however there may be situations where it is preferred to have the t-post at an angle from the vertical.

A search of prior inventions registered at the United States Patent and Trademark Office revealed tools for supporting the t-post after it is placed into the ground (U.S. Pat. Nos. 5,356,101 and 5,735,310) and another that pulls the post out of the ground (U.S. Pat. No. 5,794,918) but none that hold the post steady while it is being pounded into the ground.

Therefore there is a need for an apparatus that holds a t-post steady while it is being pounded into the ground.

There is also a need for a tool that can be used by a single worker who can both hold the post steady as well as pound it at the same time.

There is further need for a tool that can hold a t-post at any angle from the vertical so that t-posts can be pounded at desired angles.

### BRIEF SUMMARY OF THE INVENTION

To satisfy these and other needs, the invention is a metal support that can be placed on the ground where the t-post is to be situated. It is comprised of a plate that has a cylinder joined at the center of the plate, the cylinder and plate have cavities large enough to receive the t-post within allowing a minimum of play in the t-post while it is being pounded. The worker inserts the t-post into the cylinder and stands on the plate to steady it while pounding the t-post into the ground.

The angle of the cylinder from the steadying plate can be 90° if a vertical post is needed, or it can be at any other angle desired. Another possibility for setting a nonvertical post is to have a mechanical adjustment that can set the angle of the cylinder according to the needs of the situation.

### BRIEF DESCRIPTION OF THE SEVERAL VIEWS OF THE DRAWING

FIG. 1 is a front view showing the plate and vertical cylinder and optional handles and spikes.

FIG. 2 is a side view showing the plate and vertical cylinder and optional handles and spikes.

FIG. 3 is a side view showing the plate and vertical cylinder set at an angle from the vertical and optional handles and spikes.

FIG. 4 is a view of a supporting member with grooved indentations for holding removable vertical cylinder steady.

FIG. 5 is a view of a supporting member without grooved indentations for holding removable vertical cylinder steady.

FIG. 6 is a view of a disc attachment to the removable vertical cylinder with grooved indentations that mesh with the grooved indentations of the supporting member.

FIG. 7 is the front view of a removable cylinder with the disc attachment and an adjusting device.

FIG. 8 is a front view showing the plate, optional handles and spikes, removable cylinder with the disc attachment and an adjusting device, and supporting members, one having grooved indentations for meshing with the disc of the vertical cylinder component.

FIG. 9 is a top view showing the plate and vertical cylinder and optional handles.

FIG. 10 is an enlarged view of the cross-section of the shaft.

FIG. 11 is a bottom view showing the plate and vertical cylinder and optional spikes.

FIG. 12 is a view of the bottom of an apparatus wherein the cylinder is movable relative to the position of the plate showing the cavity in the plate shaped so as to accommodate the movement of the cylinder.

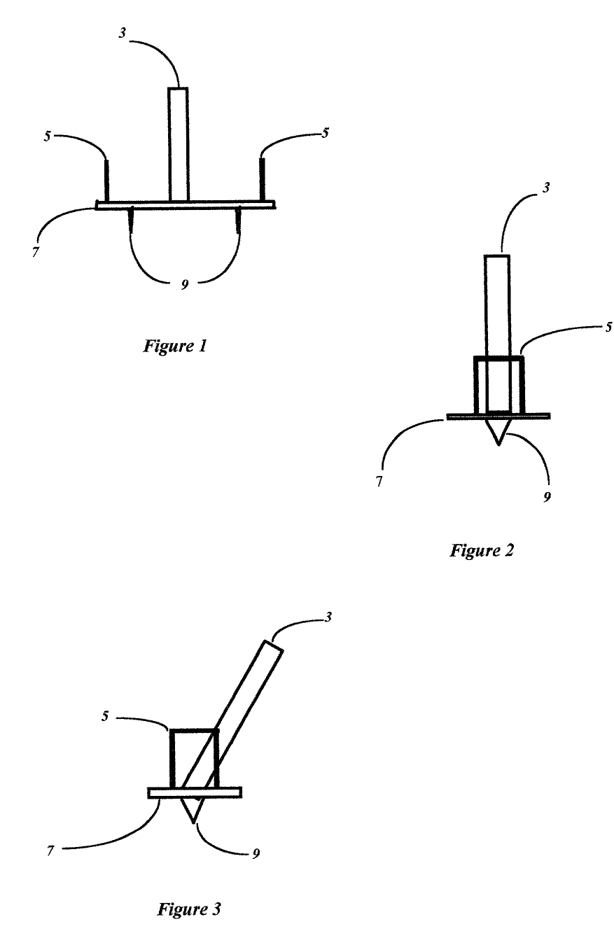

### DETAILED DESCRIPTION OF THE INVENTION

The use of t-posts and wire to contain livestock is common. Installing t-posts is relatively easy compared to wooden posts which require holes to be dug. Two people can a drive t-post, one to hold the post while the other pounds the post with a driver. However, it is very difficult for one person to drive a post because he must hold the post steady while at the same time using both hands to pound with the post driver. This is especially a problem for small farmers who often operate their farms alone. The present invention is designed so one person can easily drive t-posts into the ground without assistance.

This invention has a hollow cylinder or shaft that is joined perpendicularly to a plate that rests on the ground. The operator places the t-post into the shaft and stands on the plate, thus holding the post steady while he uses both hands to pound the post with a driver.

Referring to the Figures, a shaft 3 having a cavity within 11 that accommodates the cross-section of a t-post is attached perpendicularly to a plate 7 that also has a cavity 13 that accommodates the cross-section of a t-post. In the preferred embodiment the shaft and plate are metal and are joined by welding. The cavity 11 of the shaft is of suitable shape and sufficient size to receive said post within and to hold said post with a minimum of play is shown as a cross-section in FIG. 10. To hold the plate firmly to the ground this embodiment has protrusions 9, perhaps spikes, that sink into the ground to anchor the plate and minimize movement. To make it easier to remove the support after the post is set there are handles 5 which the operator can grasp. The shaft slides up and over the top of the post.

One variation on the basic invention is to have the shaft join the plate at an angle other than perpendicular as shown in FIG. 3. This might be desirable to accommodate a mowing machine. If the posts are slanted away from the pasture, animals grazing from within the pasture will reach through the fence and graze the other side of the fence. The mowing machine can mow beneath the wire near the posts but there is no need to crowd the post with the mower because the livestock has grazed there.

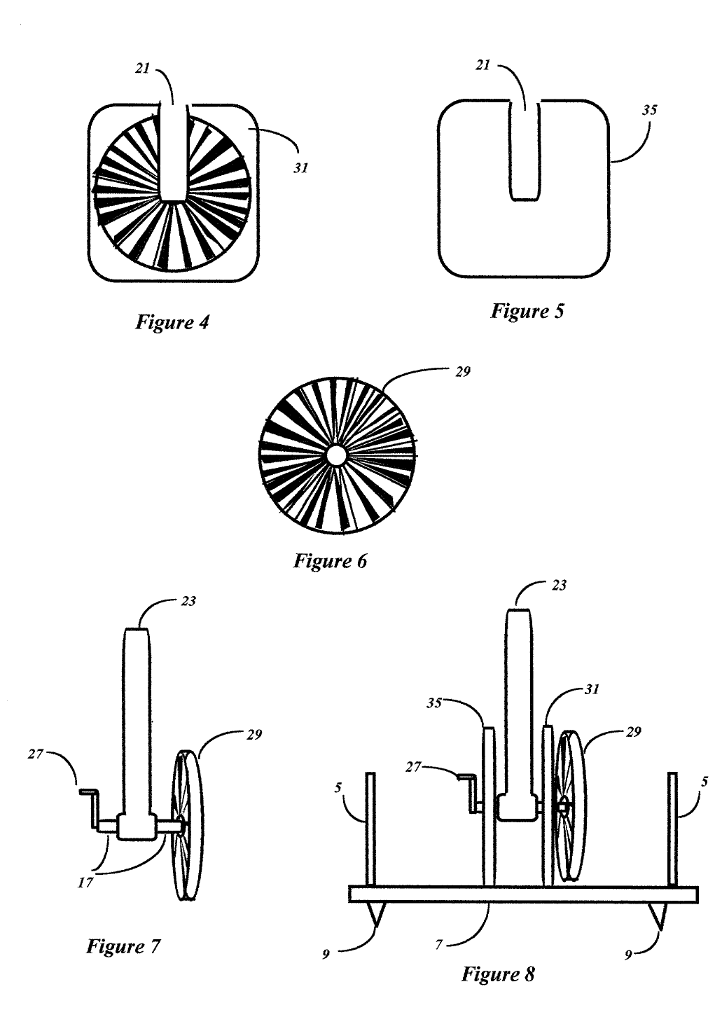

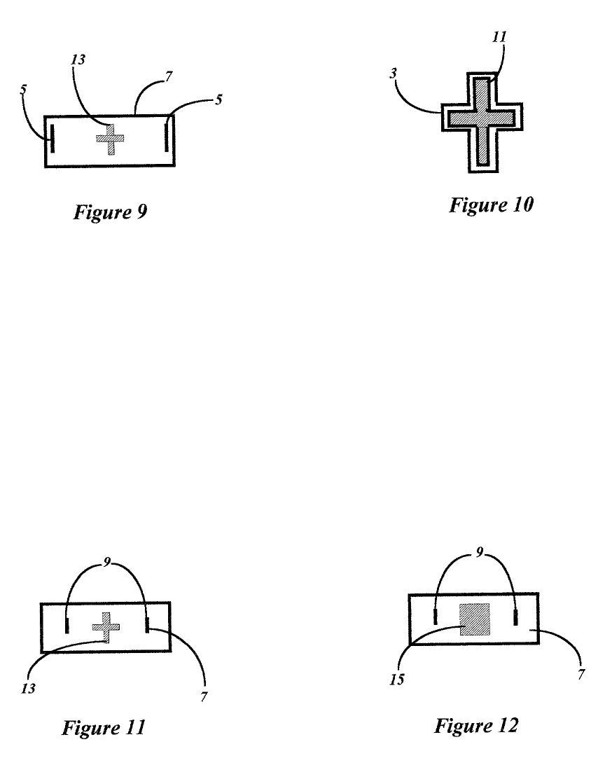

Another variation takes into consideration the varying undulations of the ground. Consider that the plate does not always lie horizontally due to uneven ground. To ensure the posts stand at the same angle from the horizontal, it is necessary to be able to move the shaft from one angle to another. In one embodiment an adjusting device may reposition the shaft relative to the plate. If the shaft position is changeable relative to the plate, then they are joined using a method, other than welding, that allows the shaft to swing from the vertical. One example of a removable component comprising the cylinder is shown in FIG. 7. Referring to FIGS. 4 through 8, the cylinder 23 is separate from the plate 7 and has a perpendicular supporting shaft 17, an adjusting device 27, and a grooved disc 29. The plate has two supporting members, one ungrooved 35 as seen in FIG. 5 and one with grooved indentations 31 as seen in FIG. 4. The supporting shaft 17 rests in slots 21 of the supporting members 31 and 35. The cylinder 23 is adjusted from the vertical by placing it at a desired angle and engaging the adjusting device 27 so that the grooved indentations of the grooved disc 29 mesh with the grooved indentations of the supporting member 31. In this embodiment the hole 15 in the plate 7 must accommodate the movement of the shaft and may not be shaped like the cross-section of the post. Referring to FIG. 12, the cavity 15 in the plate 7 is rectangular or other shape necessary to allow the shaft to be moved from one position to another.

A further variation on this embodiment could have a built-in level so vertical, or other desired angles, could be easily detected.

The advantage of a removable shaft is being able to accommodate more than one shape of post using the same steadying plate. Fencing is not the only application for metal posts. It is common to use such posts to erect road signs or support utility meters or for other support purposes. The same invention can be used by a single worker having nothing more in his truck than the post, the support and the driver. Sign posts are not normally shaped like a “T”, but rather like a “U”. A variation of the invention would have the plate and cylinder separate and joined when in use. The plate would accommodate more than one type of cylinder depending upon the cross-section of the post. The same plate can be used whether the post is the “T” type or “U” type.

A person skilled in the art could think of many uses that have not been set forth in this document.

1. An apparatus for supporting a post that is to be driven into the ground comprising a plate that has a cylinder joined at the center of said plate, said cylinder having a cavity of suitable shape and sufficient size to receive said post within and to hold said post with a minimum of play, and said plate having a cavity of suitable shape and sufficient size to receive said post within.

2. The apparatus of claim 1 wherein said plate is of sufficient area to allow a user to stand upon it while in use.

3. The apparatus of claim 1 wherein said cylinder and said plate are joined by a means that allows for setting a preferred angle between said cylinder and said plate, said means capable of securely holding said cylinder steady at said preferred angle while in use.

4. The apparatus of claim 1 wherein two handles are securely attached to said plate adjacent to said cylinder yet far enough away from said cylinder to accommodate the width of a user's foot between each of said handle and said cylinder

5. The apparatus of claim 1 wherein an anchoring device is securely attached to said plate on the side opposite the side having said attached cylinder.
